(19) United States
(12) Patent Application Publication
(10) Pub. No.: US 2016/0067596 A1
(43) Pub. Date: Mar. 10, 2016

(54) SMART ARTICLES INCLUDING A VISUAL CODE AND A TOUCH CODE

(71) Applicant: T-Ink, Inc., New York, NY (US)

(72) Inventors: John Gentile, Montclair, NJ (US); Anthony Gentile, New York, NY (US); Terrance Z. Kaiserman, Loxahatchee, FL (US); Tayler Kaiserman, Brooklyn, NY (US); Ed Ickowski, New York, NY (US); Lavern Perez, New York, NY (US); Mike Brody, New York, NY (US); Jan Thiele, Chemnitz (DE); Steven Martin Cohen, New York, NY (US)

(73) Assignee: T+Ink, Inc., New York, NY (US)

(21) Appl. No.: 14/690,348

(22) Filed: Apr. 17, 2015

Related U.S. Application Data
(60) Provisional application No. 61/980,638, filed on Apr. 17, 2014.

(51) Int. Cl. A63F 3/06; G06F 3/03

(52) U.S. Cl. CPC A63F 3/0685; A63F 3/0605; A63F 3/0665; G06F 3/03

(57) ABSTRACT

Articles including a visual code and a touch code are described. In some embodiments, the articles are smart lottery tickets.

### RELATED APPLICATIONS

This application claims priority to U.S. Provisional Application No. 61/980,638, filed Apr. 17, 2014, which is incorporated herein by reference in its entirety.

### FIELD OF INVENTION

The invention relates generally to articles (e.g., lottery tickets) including a visual code and a touch code.

### BACKGROUND OF INVENTION

Lotteries and associated lottery tickets have existed for years in the form of choosing a restricted subset of a larger number of choices. Winnings paid out are less than the sum of income from ticket sales, and the mere act of purchasing lottery tickets brings people to locations where other goods and services can be purchased. Games continuously evolve employing different strategies to yield winning results. Some lottery tickets have chosen numbers printed on the ticket at the point of sale. Other lottery tickets rely on scratching opaque coatings to reveal hidden numbers beneath. Similar may be incorporated on

[symbol]

### SUMMARY OF INVENTION

Smart articles (e.g., lottery tickets) including a visual code and a touch code are described herein. The smart articles may, for example, be a ticket, a lottery ticket, a lottery ticket sleeve, a coffee sleeve, a greeting card, a playing card, a magazine insert, a post card, a hand out, or a business card, amongst other types of articles. The codes may be designed to produce at least one probability of at least one outcome.

In one aspect, an article is provided. The article comprises a substrate, at least one visual code printed upon said substrate and at least one touch code associated with said substrate.

In some embodiments, the article includes a removable opaque coating that occludes said at least one visual code.

In some embodiments, the touch code may be printed on or within said substrate. The touch code may be embedded in said substrate. The touch code may be printed on the substrate at the point of sale. The article may include at least one second visual code printed on the substrate. The article may further comprise RFID technology and/or circuitry.

The article may comprise a top conductor. The top conductor can be used either alone or in conjunction with other codes to yield at least one different probability of at least one occurrence and/or outcome. The article can further comprise at least one line and/or perforated line delineating at least one location that at least one part of the ticket can be torn if desired to produce a new shape and/or topological configuration. At least one line and/or perforated line delineating at least one location can be at least one line of any shape that can be any of including but not limited to horizontal, vertical, diagonal, curved, geometric shapes, irregular shapes, the shape of characters, caricatures, likenesses, images, objects, celebrities, icons, logos, trademarks, names, and/or any delineating line that can be torn or bent for the purpose of producing a change in said shape and/or topological configuration. The new shape can include at least one tab and at least one slot in which the tab can be inserted upon rolling and/or folding to produce a data entry implement and/or stylus.

The article can be used as a data entry device on any capacitive touch screen of a smart device including but not limited to a smart phone, Ipad, Iphone, touch screen in car, touch sensitive screen on slot machine and/or custom capacitive sensitive screen. T

The touch code can be more than one touch code located in more than one location on the article. The touch code may be in any geometric configuration that produces at least one detectable pattern. The geometric configuration can be at least one of including but not limited to at least one circle of at least one size, at least one square and/or rectangle of at least one size, at least one line of at least one length and/or at least one width and/or at least one angle, at least one dot and or array and/or cluster of dots, and/or at least one including but not limited to numbers, letters, symbols, geometric shapes, irregular shapes, the shape of characters, caricatures, likenesses, images, objects, celebrities, icons, logos, trademarks, names.

At least one removable opaque coating can also change at least one touch code. The article can further comprise at least one removable opaque coating that changes at least one touch code with no effect on at least one visual code.

The touch code can enable the article to function as at least one game controller and/or controller stylus. The game controller and/or controller stylus can interact with at least one game of chance. The game of chance can be at least one of the following but not limited to blackjack, money wheel, Keno, any form of table poker, baccarat, mahjong, progressive betting, roulette, craps, slot machine, betting on at least one sports game including but is not limited to horse racing, boxing, wrestling, kick boxing, football, basketball, baseball, roller ball, soccer, ice hockey, tennis, billiards, pocket billiards, chess, election results. The game of chance can be at least one game of chance played in and/or out of a casino. The game of chance can be at least one electronic version of at least one game of chance played in and/or out of a casino. The game controller and/or controller stylus can be used as a digital roulette controller by spinning and/or creating a linear and/or curved motion of the game controller and/or controller stylus on the touch screen of a smart device to cause an image of a roulette wheel to spin and/or to play electronic roulette. The game controller and/or controller stylus can interact with the touch sensitive screen of a slot machine.

The article can be configured to be used on the touch screen of a smart device to bring up a menu of at least one game of chance. The game of chance can be at least one lottery. At least one lottery can be entered and at least one virtual lottery ticket can be purchased using the smart lottery ticket. At least one virtual lottery ticket in at least one lottery can be used to select numbers and/or choices and/or electronically scratch a virtually opaque area to reveal codes electronically displayed in at least one lottery. At least one lottery can be at least one real and/or virtual lottery. The game of chance can be selected, paid for, and played using the article (e.g., smart lottery ticket). The article (e.g., smart lottery ticket) can be configured for the ability to be used for a second chance and/or at least two chances regardless of whether the article (e.g., smart lottery ticket) was a winning or losing article (e.g., smart lottery ticket). The second chance and/or at least two chances can be used for gaming options.

The article is configured to be used to order products and/or services and/or articles and/or gaming options. The article can further comprise at least one visual code. At least one visual code can be at least one of the following but not limited to non-conductive bar code, QR code, visual code, UV printing, IR printing, at least one printed area that causes any type and/or combination of polarization of light of at least one frequency and/or at least one frequency band, and/or at least one magnetic strip and/or area. At least one touch code can work in conjunction with at least one visual code to produce at least one additional code within a code. At least one code within a code can multiply and/or alter the probability of at least one outcome and/or occurrence.

At least one article can be used in conjunction with and/or create a daisy chain with at least one other article to create at least one combined code. At least one combined code can created using two articles. At least one combined code can be created using three articles. At least one combined code can be created using four articles. At least one combined code can be created using five articles. At least one combined code can be created using more than five smart articles. At least one combined code creates more possible gaming options. At least one combined code can involve gestures and/or movement of at least one portion of at least one article (e.g., smart lottery ticket) across a touch screen of a smart device. At least one combined code can further involve placing the article against a smart screen in at least one sequence, wherein at least one sequence can be placing at least one portion of the article against the screen of a smart device followed by placing at least one other portion of the article against the screen of a smart device. At least one combined code can further comprise a multiplicity of touch codes in a multiplicity of locations on an article, and at least one combined code can comprise any touch code placed upon the screen of a smart device followed by any other touch code placed upon the screen of a smart device any number of times and in any sequence and/or orientation of the touch code. The daisy chain can create a resultant resistance that can be detected and can produce a discriminate. The discriminate can be used to alter a program path. At least one combined code can be at least one combined code created in at least one location.

The new shape of a torn article (e.g., smart lottery ticket) can create a new code that is used either alone or in addition to other codes.

At least one touch code can be the address to a website and/or causes a smart device to go to a website and/or webpage.

At least one combined code can be created in at least one location and can be used to solve puzzles via cooperative involvement with at least one purchaser of at least one article (e.g., smart lottery ticket).

The article can be configured to be used for a treasure hunt and/or scavenger hunt. The treasure hunt and/or scavenger hunt can involve at least one data entry terminal in at least one venue. The treasure hunt and/or scavenger hunt can involve at least one person. The venue can be at least one of a cruise ship, casino, hotel, restaurant, banquet hall, theme park, amusement park, resort, beach house, golf course, marina, sports stadium, home, office, airport, bus terminal, train terminal.

The article can be configured to be used as a playing card for use on any screen capable of reading at least one touch code. The playing card can produce at least one extra chance and/or multiple chances to improve winning and or facilitate gaming options.

At least one combined code can create at least one locked box only accessible using at least one article (e.g., smart lottery ticket) used to create at least one locked box. At least one locked box can contain at least one of the following including but not limited to at least one: data base, communication, e-mail, tweet, post, chat room entry, code, password, encryption key, account number, pin number, access code, program, data, note, transcript, audio and/or video file, bit coin, piece of information. The smart article (e.g., lottery ticket) can further comprise and employ error correction.

The touch code can be used in conjunction with a data base to record time and location of purchase. The data base to record time and location of purchase can be matched if possible with a visual image and/or voice recording of the purchaser to produce a tracking ID. The tracking ID can be used to track the movement of the purchaser. The data base and/or tracking ID can be used for fraud detection and/or to detect a counterfeit article.

The touch code can be used in conjunction with a data base to record time and location in a new venue. The new venue can be used in conjunction with the data base to provide at least one venue-specific special. At least one venue-specific special and/or presence in a new venue can be used in combination with at least one other at least one venue-specific special and/or at least one other new venue to improve chances of earning and/or winning more gaming options.

In another aspect, a smart article (e.g., lottery ticket) dispensing machine is configured to dispense a smart article (e.g., lottery ticket and/or lottery ticket) and to tally the sale at the point of sale for automatic inventory control.

Although preferred embodiments of the present invention have been described it will be understood by those skilled in the art that the present invention should not be limited to the described preferred embodiments. Rather, various changes and modifications can be made within the spirit and scope of the present invention.

### BRIEF DESCRIPTION OF DRAWINGS

FIG. 1 depicts one embodiment of an article (e.g., smart lottery ticket) with numbers that can be chosen and a touch code applied on the same ticket.

FIG. 2 depicts one embodiment of an article (e.g., smart lottery ticket) with a type of touch code.

FIG. 3 depicts one embodiment of an article (e.g., smart lottery ticket) with a type of touch code.

FIG. 4A depicts an embodiment of an article (e.g., smart lottery ticket) with perforated areas from which pieces of the ticket can be torn to select one of many possible touch codes.

FIG. 4B depicts the article (e.g., smart lottery ticket) of FIG. 4A with pieces torn away to produce a unique touch code.

FIG. 5A-C depicts an article (e.g., smart lottery ticket) that can be reused to create a conductive data entry stylus for use on the touch screen of a smart device.

### DETAILED DESCRIPTION

Smart articles (e.g., lottery tickets) including a visual code and a touch code are described herein.

FIG. 1 depicts an article (e.g., smart lottery ticket) 1A with a visual code 2 and a touch code 3. In the illustrative embodiment, the visual code is in the form of numbers and the touch code is in circular chain. The circular chain touch code 3 is formed from different circles (that can be of different sizes) of conductive material connected together at different angles and varying distances from one another, and this can produce a number of possibilities.

It should be understood that other types of visual codes and touch codes are also possible.

The visual code can be at least one of including but not limited to numbers, letters, symbols, logos, trademarks, caricatures, shapes, characters, likenesses, images, objects, and products. The code may depict celebrities, icons, names, points, inducements, trips, discounts, cars, gifts, prizes, jewelry, perfume, clothing, accessories, guns, ammunition, meals, alcohol, hotel accommodations, travel options, airline tickets, services, and insurance.

In some embodiments, the visual code may be in plain view. In other embodiments, the visual code may be hidden and revealed when an opaque material is scratched off the surface of article.

In some embodiments, a touch code may include a pattern that is detectable by a sensor. For example, a touch code may include a conductive and/or dielectric pattern that is detectable by a capacitive sensor (e.g., a capacitive touch screen). The pattern may be formed on an object (e.g., a lottery ticket), and may be configured to interact with the capacitive sensor and thereby cause the capacitive sensor to generate a signal. Any suitable technique or combination of techniques may be used to form the pattern, including, but not limited to, printing using conductive ink.

Suitable touch code structure and techniques have been described in the following applications and patents which are incorporated herein by reference in their entireties: U.S. patent application Ser. No. 13/120,996, titled “PLANAR DATA CARRIER,” filed on Aug. 16, 2011; U.S. patent application Ser. No. 13/127,512, titled “IDENTIFICATION SYSTEM AND APPLICATIONS,” filed on Jul. 1, 2011; U.S. patent application Ser. No. 13/703,467, titled “SYSTEM COMPRISING A CAPACITIVE INFORMATION CARRIER FOR ACQUIRING INFORMATION,” filed on Jan. 24, 2013; U.S. patent application Ser. No. 13/825,159, titled “INFORMATION CARRIER AND SYSTEM FOR ACQUIRING INFORMATION,” filed on Jul. 3, 2013; and U.S. Pat. No. 8,497,850, titled “SYSTEM AND METHOD FOR RETRIEVING INFORMATION FROM AN INFORMATION CARRIER BY MEANS OF A CAPACITIVE TOUCH SCREEN,” issued on Jul. 30, 2013.

The pattern of a touch code may be configured to encode information. For example, the pattern may include one or more regions. Any suitable characteristic or combination of characteristics of the regions may be used to encode information, including, but not limited to, size, shape, orientation, number, distance between regions, and/or relative position between regions. For example, the pattern may include a series of rectangular bars of various sizes, a collection of circles of various sizes and angular relationships to one another, and/or any suitable arrangement of geometric shapes (e.g., points, lines, triangles, cubes, etc.). These shapes may be arranged in a two-dimensional plane, or in three-dimensional space (e.g., in multiple layers).

In some embodiments, a suitable arrangement scheme may be used under which a number of different arrangements of regions may be possible, where each arrangement may be capable of causing a capacitive sensor to generate a different signal. For example, a scheme having at least eight detectably different arrangements may be used to encode three bits of information, with each of the eight arrangements being decoded into one of eight possible 3-bit strings (e.g., 000, 001, 010, etc.).

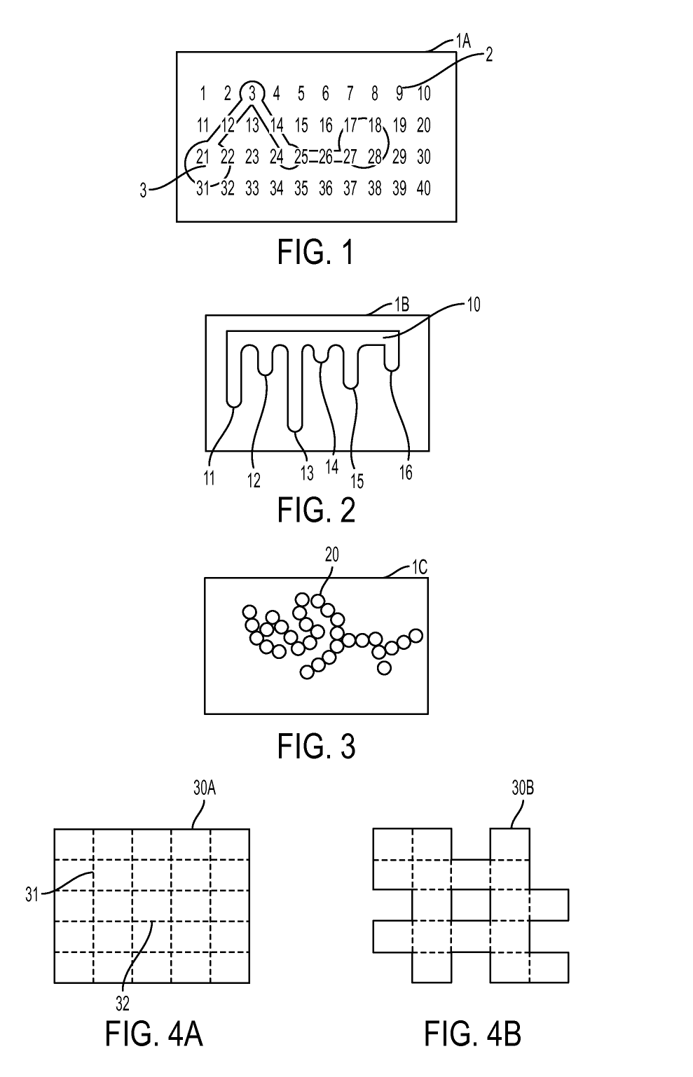

FIG. 2 depicts one embodiment of an article (e.g., smart lottery ticket) 1B with a type of linear touch code 10. Shown for example is a first conductive element 11, second conductive element 12, third conductive element 13, fourth conductive element 14, fifth conductive element 15, and sixth conductive element 16. If each conductive element can be one of ten different and detectable lengths, the six linear elements taken together will produce one million possible combinations, and this can multiply other probabilities and/or increase the dimensions of combinatorial possibilities.

FIG. 3 depicts another embodiment of an article (e.g., smart lottery ticket) 1C with a bead type touch code 20. In this form of code the number of beads, placement of beads, and size of beads can all influence the number of possible configurations and corresponding possibilities.

FIG. 4A depicts an embodiment of an article (e.g., smart lottery ticket) 30A with perforated areas from which pieces of the ticket can be torn to select one of many possible touch codes. In this case, vertical perforated lines 31 and horizontal perforated lines 32 are shown, though perforations are not limited to vertical or horizontal and can be any shape including but not limited to horizontal, vertical, diagonal, curved, geometric shapes, irregular shapes, the shape of characters, likenesses, caricatures, images, objects, celebrities, icons, logos, trademarks, names, and/or any delineating line that can be torn or bent for the purpose of producing a change in shape and/or topological configuration.

FIG. 4B depicts the article (e.g., smart lottery ticket) 30A of FIG. 4A with pieces torn away to produce a unique tear touch code 30B. The article (e.g., smart lottery ticket) 30A depicts twenty-five possible tear locations, and this produces 33,554,432 possible combinations. In the form shown many of these combinations would cause the article (e.g., smart lottery ticket) to fall apart, but it is shown for example only. An actual article (e.g., smart lottery ticket) would have portions removed from any number of locations to keep the ticket mechanically intact. This could include torn elements from the perimeter of the ticket and areas removed from within the body of the ticket that leave enough of the ticket to hold all portions together.

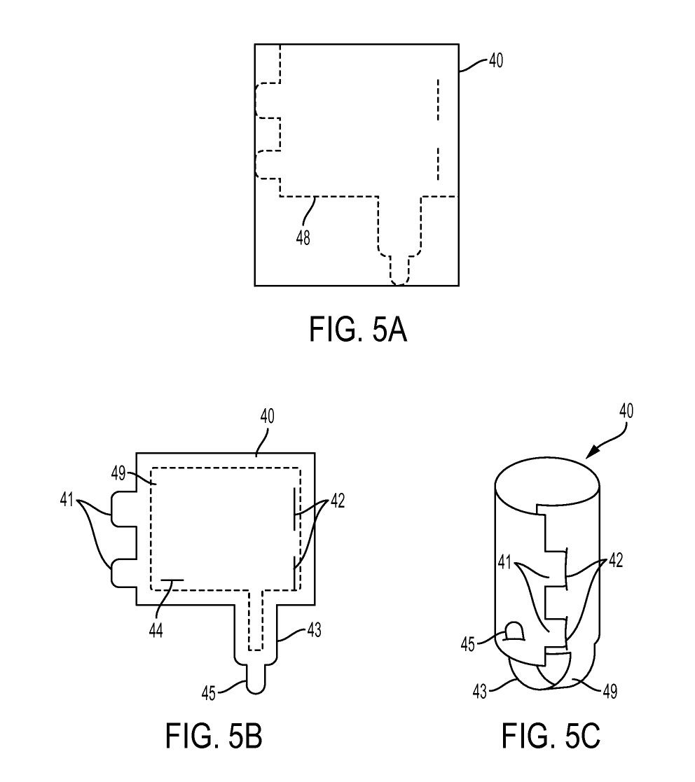

FIG. 5A-C depicts a stylus article (e.g., smart lottery ticket) 40 that can be reused to create a conductive data entry stylus for use on the touch screen of a smart device. In this example, perforated lines 48 are shown in FIG. 5A, which also depicts the starting shape of the article 40.

FIG. 5A depicts a new shape with material removed along the perforated lines 48, thus producing tabs 41, slots 42, stylus slot 44, stylus tab 45, stylus touch contact 43, and stylus conductive area 49 (on under side of the paper) as shown in FIG. 5B. FIG. 5C depicts a stylus formed by folding stylus article 40 such that tabs 41 insert into slots 42, and stylus tab 45 inserts into stylus slot 44, thus enabling stylus conductive area 49 to be exposed on stylus touch contact 43. In this manner a hand-held data entry device can be constructed from a flat stylus article (e.g., smart lottery ticket) 40, thus keeping a lottery ticket alive and in the hand of a user, and viewable. Styluses are not limited to this particular topological configuration, and this is merely shown for example only.

Gaming options may be at least one of including but not limited to the item and/or product and/or service and/or discounts for the item and/or product and/or service:

lottery ticket, special offer and/or inducement, promotion, gift, cash, club admission, adult services where legal, recreational drugs where legal, airline ticket, travel package, vacation, cruise, metro card, public transportation card and/or access, transportation, gasoline, hotel accommodation, upgraded status, jackpot, casino chip, jewelry, perfume, clothing, insurance, guns, ammunition, food, alcohol, tours, shows, movies, more lottery tickets, points that can be used toward anything herein.

A smart device may be any device with a capacitive touch screen such as including but not limited to a smart phone, Ipad, Iphone, touch screen in car, touch sensitive screen on slot machine and/or custom capacitive and/or touch sensitive screen.

A top conductor may be a formulation of ink containing different concentrations of inclusions of different sizes and shapes, and this enables ink formulations of varying compositions to encode information.

What is claimed is:

1. An article comprising:
a substrate;
at least one visual code printed upon said substrate; and
at least one touch code associated with said substrate.

2. The article according to claim 1, wherein the touch code is printed on or within said substrate.

3. The article according to claim 1, wherein the touch code is embedded in said substrate.

4. The article according to claim 1, further comprising at least one removable opaque coating occluding said at least one visual code.

5. The article according to claim 1, wherein said article is at least one of including but not limited to a ticket, lottery ticket, lottery ticket sleeve, coffee sleeve, greeting card, playing card, magazine insert, post card, hand out, business card.

6. The article according to claim 1, further comprising at least one second visual code printed upon said substrate.

7. The article according to claim 1, wherein said at least one touch code is printed on said substrate at the point of sale.

8. The article according to claim 1, further comprising RFID and/or circuitry.

9. The article according to claim 1, further comprising a top conductor.

10. The article according to claim 1, wherein said top conductor is used either alone or in conjunction with other codes to yield at least one different probability of at least one occurrence and/or outcome.

11. The article according to claim 1, further comprising at least one line and/or perforated line delineating at least one location that at least one part of said article is torn if desired to produce a new shape and/or topological configuration.

12. The article according to claim 1, wherein said at least one line and/or perforated line delineating at least one location is at least one line of any shape that can be any of including but not limited to horizontal, vertical, diagonal, curved, geometric shapes, irregular shapes, the shape of characters, caricatures, likenesses, images, objects, celebrities, icons, logos, trademarks, names, and/or any delineating line that can be torn or bent for the purpose of producing a change in said shape and/or topological configuration.

13. The article according to claim 1, wherein said new shape includes at least one tab and at least one slot in which said at least one tab can be inserted upon rolling and/or folding of said new shape to produce a data entry implement and/or stylus.

14. The article according to claim 1, wherein said article is used as a data entry device on any capacitive touch screen of a smart device including but not limited to a smart phone, Ipad, Iphone, touch screen in car, touch sensitive screen on slot machine and/or custom capacitive sensitive screen.

15. The article according to claim 1, wherein said at least one touch code is more than one touch code located in more than one location in said article.

16. The article according to claim 1, wherein said touch code is in any geometric configuration that produces at least one detectable pattern.

17. The article according to claim 1, wherein said any geometric configuration is at least one of including but not limited to at least one circle of at least one size, at least one square and/or rectangle of at least one size, at least one line of at least one length and/or at least one width and/or at least one angle, at least one dot and or array and/or cluster of dots, and/or at least one including but not limited to numbers, letters, symbols, geometric shapes, irregular shapes, the shape of characters, caricatures, likenesses, images, objects, celebrities, icons, logos, trademarks, names.

18. The article according to claim 1, wherein said at least one removable opaque coating also changes said at least one touch code.

19. The article according to claim 1, further comprises at least one removable opaque coating that changes said at least one touch code with no effect on said at least one visual code.

20. The article according to claim 1, wherein said at least one touch code enables functioning as at least one game controller and/or controller stylus.

21-72. (canceled)
